(19) United States
(12) Patent Application Publication
(10) Pub. No.: US 2020/0073678 A1
(43) Pub. Date: Mar. 5, 2020

(54) SYSTEMS AND METHODS FOR OPERATING SYSTEM DEPLOYMENT

(71) Applicant: Dell Products L.P., Round Rock, TX (US)

(72) Inventors: Charles D. STRACENER, Carrollton, TX (US); Sanjay RAO, Austin, TX (US); Sankara Rao GARA, Cedar Park, TX (US); Steven James FAGAN, Round Rock, TX (US); Dallin Wayne STRONG, Round Rock, TX (US); Chandran VENKATACHALAM, Round Rock, TX (US); Krishna K. KANUKURTHY, Austin, TX (US); Lokesh Krishna BANGERA, Round Rock, TX (US); Joe RAZO, Cedar Park, TX (US)

(73) Assignee: Dell Products L.P., Round Rock, TX (US)

(21) Appl. No.: 16/119,886

(22) Filed: Aug. 31, 2018

(51) Int. Cl. G06F 9/445; G06F 8/65; G06F 8/61

(52) U.S. Cl. CPC G06F 9/44505; G06F 8/61; G06F 8/65

(57) ABSTRACT

An information handling system may include a processor, a memory coupled to the processor, and a management controller configured to provide out-of-band management of the information handling system. The management controller may be configured to receive a user instruction to deploy the information handling system. Without any additional user instructions, the management controller may be configured to: access a configuration file specifying attributes of the deployment; based on the configuration file, update at least one firmware of the information handling system; based on the configuration file, configure at least one information handling resource of the information handling system; and based on a location specified by the configuration file, install an operating system onto a physical storage resource of the information handling system.

### TECHNICAL FIELD

The present disclosure relates in general to information handling systems, and more particularly to systems and methods for deploying information handling systems, including operating system deployment.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As described in further detail below, management controllers may be used to provide management facilities for information handling systems. In particular, a management controller may be used to deploy a new information handling system (or re-deploy an existing information handling system, for example to be repurposed for use in a new role).

For purposes of this disclosure, the term “deploy” includes the initial setup procedure for an information handling system (e.g., including tasks such as updating firmware, configuring hardware, installing an operating system, updating drivers, etc.). The term “deploy” also includes re-deploying an existing information handling system.

In some instances, it may be advantageous to deploy an information handling system as a clone (or substantial clone) of an existing system. Further, it may be advantageous to do so with a minimum of required user interactions. According to some embodiments, the systems and methods described herein may provide such functionality. Existing solutions, on the other hand, may include one or more manual steps of initiating a particular task, waiting for its completion, validating its results, and then initiating the next task.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with deployment of information handling systems may be reduced or eliminated.

In accordance with embodiments of the present disclosure, an information handling system may include a processor, a memory coupled to the processor, and a management controller configured to provide out-of-band management of the information handling system. The management controller may be configured to receive a user instruction to deploy the information handling system. The management controller may further be configured to, without any additional user instructions: access a configuration file specifying attributes of the deployment; based on the configuration file, update at least one firmware of the information handling system; based on the configuration file, configure at least one information handling resource of the information handling system; and based on a location specified by the configuration file, install an operating system onto a physical storage resource of the information handling system.

In accordance with these and other embodiments of the present disclosure, a method may include a management controller that is configured to provide out-of-band management of an information handling system receiving a user instruction to deploy the information handling system. The method may further include the management controller, without any additional user instructions: accessing a configuration file specifying attributes of the deployment;

based on the configuration file, updating at least one firmware of the information handling system; based on the configuration file, configuring at least one information handling resource of the information handling system; and based on a location specified by the configuration file, installing an operating system onto a physical storage resource of the information handling system.

In accordance with these and other embodiments of the present disclosure, an article of manufacture may include a non-transitory, computer-readable medium having instructions thereon that are executable by a processor of a management controller of an information handling system for: receiving a user instruction to deploy the information handling system; and without any additional user instructions: accessing a configuration file specifying attributes of the deployment; based on the configuration file, updating at least one firmware of the information handling system; based on the configuration file, configuring at least one information handling resource of the information handling system; and based on a location specified by the configuration file, installing an operating system onto a physical storage resource of the information handling system.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates a flow chart of an example method, in accordance with embodiments of the present disclosure.

### DETAILED DESCRIPTION

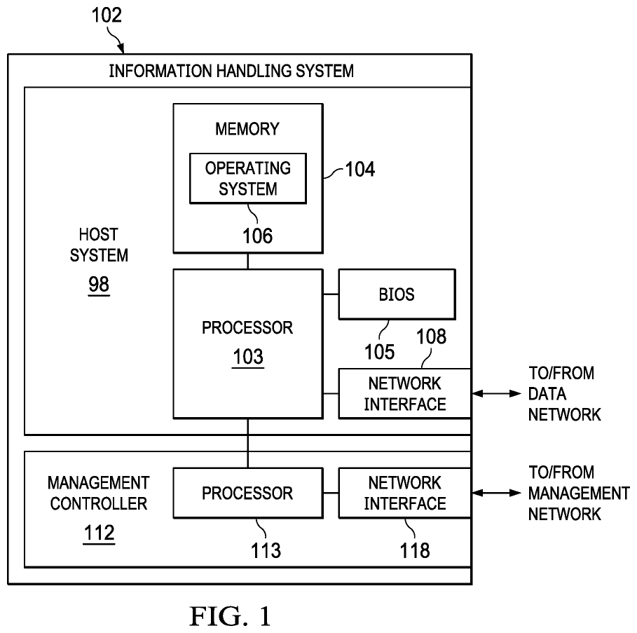

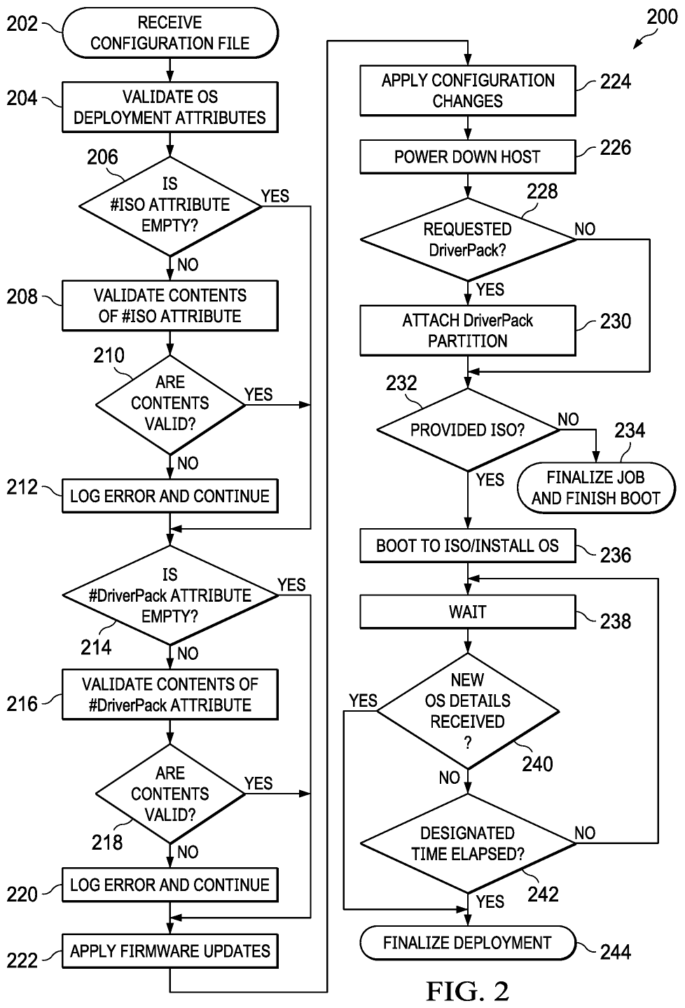

Preferred embodiments and their advantages are best understood by reference to FIGS. 1 through 2, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a baseboard management controller (BMC), a chassis management controller (CMC), or a remote access controller (e.g., a Dell Remote Access Controller or Integrated Dell Remote Access Controller). In some embodiments, a management controller may include a lifecycle controller, as will be understood by one of ordinary skill in the art with the benefit of this disclosure.

For the purposes of this disclosure, the terms “console” and “management console” may be used interchangeably to refer broadly to systems that are configured to couple to a management controller and issue management instructions for an information handling system that is being managed by the management controller. One example of such a console is the Dell OpenManage Essentials systems management console. In various embodiments, management consoles may be implemented via specialized hardware and/or via software running on a standard information handling system.

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As noted above, management controller 112 may be used in deployment of information handling system 102. A user or administrator may interact with management controller 112 in order to instruct it to accomplish various deployment tasks, such as updating firmware, configuring various information handling resources (e.g., creating virtual disks), deploying an operating system (e.g., installing an operating system onto a physical storage medium of information handling system 102), installing drivers, etc.

According to some embodiments, a single configuration file (e.g., an Extensible Markup Language (XML) or Javascript Object Notation (JSON) file) may specify any or all of the various attributes used in deploying an information handling system. In some embodiments, such a configuration file may be exported from a management controller of an existing information handling system to allow a profile of the existing system to be imported via the management controller of the information handling system to be deployed. This may allow for a given configuration to be cloned or substantially cloned. If the administrator wishes to make changes to any attributes of the configuration file before deployment, a “substantial clone” may result. For example, attributes such as hostname, service tag number, and other system-specific information may be changed or inserted prior to importation.

In some embodiments, a configuration file may also be configured to initiate firmware updates via a feature known as a Repository Update. Such firmware updates may be applied to any information handling resource in the system.

In some embodiments, a configuration file may also specify a location for operating installation media, such that the import process may perform an unattended installation of the operating system. For example, the configuration file may specify an image file available via the network (e.g., an ISO file), or it may specify a local resource containing the installation media (e.g., a USB device or an optical drive).

The exporting process may by default generate a configuration file that contains some empty attribute that provide the framework for successfully staging the operating system deployment task. The user may then fill in such empty attributes prior to importing the configuration file on the system to be deployed.

For example, the Repository Update logic mentioned above may allow the user to provide the location of a catalog file that contains the information for firmware updates. For operating system deployment, the user may provide network share information (or a local media location) via these attributes which point to the operating system image on the share. The user may also provide a name of the operating system to facilitate obtaining the correct drivers (e.g., from an embedded DriverPack that is installed on a lifecycle controller of the management controller). In some embodiments, the latest Driver pack may also be downloaded and installed on the lifecycle controller via repository updates, such that the latest drivers may be used during OS Deployment.

The listing below shows an example of some attributes that may be specified in a configuration file.

```
<SystemConfiguration Model=“” ServiceTag=“” TimeStamp=“”>
    <Component FQDD=“System.Embedded.1”>
        <!-- This example operates under the assumption
    that the files listed below are pathed relative to this
    configuration file -->
        <Attribute Name=“OSDeployment#ISO”>ISOs/
    operatingsystem.iso</Attribute>
        <Attribute Name=“OSDeployment#DriverPack”>drivers/
    driverpack.zip</Attribute>
        <Attribute Name=“RepositoryUpdate”>updates/
    catalog.xml</Attribute>
        <!-- The network share may include: -->
        <!-- ./Example1.xml -->
        <!-- ./ISOs/operatingsystem.iso -->
        <!-- ./drivers/driverpack.zip -->
        <!-- ./updates/catalog.xml -->
    </Component>
</SystemConfiguration>
```

In the embodiment shown, the configuration file is formatted as XML, but one of ordinary skill in the art with the benefit of this disclosure will appreciate that any suitable format may be used (e.g., JSON, CSV, etc.).

Importing a configuration may cause the importing management controller to validate the network share information provided by the user. The import operation may first apply any firmware updates detected by the Repository Update feature. Next, the process may apply all device configuration changes detected in the profile. The process may then acquire the driver pack for the selected operating system from an embedded DriverPack, attach it to the server (e.g., as a USB device), and finally boot to the network operating system image. This image may be a standard operating system image or an image that will trigger an unattended installation. (In some embodiments, the operating system may be installed from an attached USB key or DVD.)

Many modern operating systems are configured to send installation details such as their version information and hostname to the management controller once installation has completed, and so the importation process may wait for this notification to determine that the operating system installation has finished. Because there is no fully standardized way of detecting completion of the operating system installation, however, in some embodiments, once the operating system image has launched, the importation process may wait for a predetermined amount of time (e.g., 2 hours) or until it receives a notification that the operating system has completed the installation (whichever comes first). Then the USB device containing the operating system drivers may be detached from the system, and the job marked as complete.

The user may be provided with an end-to-end deployment solution that includes firmware update, hardware configuration, operating system deployment, and driver updates all within a single editable profile that can be deployed to any number of systems. This may remove the need for the user to script a separate operating system deployment workflow and/or provide manual intervention. Thus in some embodiments, the user may instruct the management controller to deploy the information handling system based on the configuration file, and without any further user instructions or input, the entire deployment process may proceed to completion.

In some embodiments a management console may be used to initiate such a process, but in other embodiments, no such management console may be needed. That is, a user may interact directly with the information handling system to be deployed in order to initiate the deployment process.

FIG. 2 illustrates a flow chart of an example method 200 for controlling information handling system management, in accordance with embodiments of the present disclosure. According to certain embodiments, method 200 may begin at step 202. As noted above, teachings of the present disclosure may be implemented in a variety of configurations of information handling system 102. As such, the preferred initialization point for method 200 and the order of the steps comprising method 200 may depend on the implementation chosen. In these and other embodiments, method 200 may be implemented as hardware, firmware, software, applications, functions, libraries, or other instructions.

At step 202, a management controller receives a configuration file for deployment of an information handling system. As discussed above, such a configuration file may be exported from an existing information handling system, possibly with additions or changes to one or more attributes. In other embodiments, the configuration file need not come from an existing system but may be generated programmatically or manually.

At steps 204, 206, 208, and 210, the management controller may validate the various operating system deployment attributes of the configuration file and check the #ISO attribute, which specifies the location (if any) of the operating system installation media. If there are any errors, they are logged at step 212, and the process continues.

At steps 214, 216, and 218, the management controller validates the #DriverPack attribute, which specifies the location (if any) of a set of drivers to be installed. If there are any errors, they are logged at step 220, and the process continues.

At step 222, any needed firmware updates are applied.

At step 224, any needed configuration changes are applied. For example, hardware information handling resources may be configured at this step. As one example of such hardware configuration, the management controller may establish one or more virtual disks that may be used when the operating system is subsequently installed.

At step 226, the host system of the information handling system is powered down.

If, at step 228, a driver pack was specified in the configuration file, then a partition containing the necessary drivers is attached at step 230. If no location for an installation ISO for an operating system is provided at step 232, then the process completes at step 234.

If, however, an ISO (or other suitable installation media) was provided, then the system boots to such installation media at step 236.

At step 238, the system waits for the operating system to finish installing. If at step 240, new operating system details (e.g., hostname and version information) have been received, then the process completes at step 244. If not, the system waits for a designated amount of time (e.g., 2 hours) to allow the operating system to finish installation. Once the designated period of time has elapsed, the process completes regardless of whether or not the operating system details have been received.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented using any of the various components disclosed herein (such as the components of FIG. 1), and/or any other system operable to implement method 200. In certain embodiments, method 200 may be implemented partially or fully in software and/or firmware embodied in computer-readable media.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution,

Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

1. An information handling system comprising:
a processor;
a memory coupled to the processor; and
a management controller configured to provide out-of-band management of the information handling system, wherein the management controller is configured to receive a user instruction to deploy the information handling system, and is further configured to, without any additional user instructions:
access a configuration file specifying attributes of the deployment, wherein the configuration file was generated with at least one empty attribute, and wherein the at least one empty attribute has been edited to include information specific to the information handling system;
based on the configuration file, update at least one firmware of the information handling system;
based on the configuration file, configure at least one information handling resource of the information handling system; and
based on a location specified by the configuration file, install an operating system onto a physical storage resource of the information handling system.

2. The information handling system of claim 1, wherein the user instruction to deploy the information handling system is received from the information handling system and is not based on a management console.

3. The information handling system of claim 1, wherein configuring the at least one information handling resource includes creating at least one virtual disk.

4. The information handling system of claim 1, wherein the management controller is further configured to access at least one driver from a storage medium accessible to the management controller and cause the driver to be installed on the information handling system.

5. The information handling system of claim 1, wherein the management controller comprises a lifecycle controller.

6. The information handling system of claim 1, wherein the configuration file comprises at least one of Extensible Markup Language (XML) or Javascript Object Notation (JSON).

7. The information handling system of claim 1, wherein the location specified by the configuration file is a network location.

8. The information handling system of claim 1, wherein the location specified by the configuration file is a physical storage medium local to the information handling system.

9. A method comprising:
a management controller that is configured to provide out-of-band management of an information handling system receiving a user instruction to deploy the information handling system;
the management controller, without any additional user instructions:
accessing a configuration file specifying attributes of the deployment;
based on the configuration file, updating at least one firmware of the information handling system;
based on the configuration file, configuring at least one information handling resource of the information handling system; and
based on a location specified by the configuration file, installing an operating system onto a physical storage resource of the information handling system;
wherein the method further comprises exporting the configuration file from a second information handling system to clone a configuration of the second information handling system onto the information handling system;
wherein the exported configuration file includes at least one empty attribute, and wherein the method further includes adding information to the empty attribute prior to the accessing.

10-12. (canceled)

13. The method of claim 9, wherein the user instruction to deploy the information handling system is received from the information handling system and is not based on a management console.

14. An article of manufacture comprising a non-transitory, computer-readable medium having computer-executable code thereon that is executable by a processor of a management controller of an information handling system for:
receiving a user instruction to deploy the information handling system; and
without any additional user instructions:
accessing a configuration file specifying attributes of the deployment, wherein the configuration file was generated with at least one empty attribute, and wherein the at least one empty attribute has been edited to include information specific to the information handling system;
based on the configuration file, updating at least one firmware of the information handling system;
based on the configuration file, configuring at least one information handling resource of the information handling system; and
based on a location specified by the configuration file, installing an operating system onto a physical storage resource of the information handling system.

15. The article of claim 14, wherein the code is further for:
configuring the at least one information handling resource by creating at least one virtual disk.

16. The article of claim 14, wherein the user instruction to deploy the information handling system is received from the information handling system and is not based on a management console.

17. The article of claim 14, wherein the code is further for accessing at least one driver from a storage medium accessible to the management controller and causing the driver to be installed on the information handling system.

18. The article of claim 17, wherein the causing the driver to be installed is subsequent to the installing the operating system.

19. The article of claim 14, wherein the management controller comprises a lifecycle controller.

20. The article of claim 14, wherein the location specified by the configuration file is a network location.
